(19) United States
(12) Patent Application Publication
(10) Pub. No.: US 2015/0020138 A1
(43) Pub. Date: Jan. 15, 2015

(54) MMT ASSET STRUCTURE FOR SUPPORTING RANDOM ACCESS TO SYSTEMS FOR TRANSMITTING CODED MEDIA DATA IN HETEROGENEOUS NETWORKS, AND METHOD AND APPARATUS FOR GENERATING SAME

(71) Applicant: Electronics and Telecommunications Research Institute, Daejeon (KR)

(72) Inventor: Seong Jun Bae, Daejeon (KR)

(21) Appl. No.: 14/375,719

(22) PCT Filed: Feb. 5, 2013
(86) PCT No.: PCT/KR2013/000921

§ 371 Date: Jul. 30, 2014

(30) Foreign Application Priority Data
Feb. 6, 2012 (KR) 10-2012-0011985
Feb. 4, 2013 (KR) 10-2013-0012439

(51) Int. Cl. H04N 21/234; H04N 21/238

(52) U.S. Cl. CPC H04N 21/234; H04N 21/238
USPC 725/116

(57) ABSTRACT

The present invention relates to an MMT asset structure providing free access to an M-unit existing in a specific MMT asset by using an indicator indicating the position of the M-unit and an indicator indicating the size of the M-unit in an MMT asset configuration, and to a method and apparatus for generating same.

### CROSS-REFERENCE TO RELATED APPLICATIONS

This application claims the benefit of priority of Korean Patent Application No. 10-2012-0011985 filed on Feb. 6, 2012 and Korean Patent Application No. 10-2013-0012439 filed on Feb. 4, 2013, all of which is incorporated by reference in its entirety herein.

### TECHNICAL FIELD

The present invention relates to a method for transporting media data and more particularly, a method for generating transport units of coded media data for a system meant to transport coded media data through a heterogeneous IP network.

### BACKGROUND ART

The MPEG-2 system is a standard for specifying functions such as packetization, synchronization, multiplexing and so on required for transporting AV (Audio Video) contents through a broadcasting network, which has standardized the MPEG-2 TS (Transport Stream) technology and is in wide use today. However, the MPEG-2 TS is found ineffective for a new environment such as the one employing All-IP (Internet Protocol) network.

Accordingly, a new media transport technology is required for a system meant to transport coded media data through a heterogeneous IP network by taking account of a current new media transport environment and a media transport environment expected to come in a near future.

### DISCLOSURE

### Technical Problem

The present invention has been made in an effort to provide a structure of an MMT asset providing random access for a system transporting coded media data in a heterogeneous network and a method and an apparatus for generating the MMT asset.

### Technical Solution

In a method for generating an MMT asset for transporting media data in a system meant for transporting coded media data, a method for generating an MMT asset comprises receiving media data including a media processing unit (MPU); generating random access information; and generating MMT (MPEG Media Transport) asset by using the media data and the random access information.

The random access information comprises an indicator representing the number of media processing units included in the MMT asset.

The random access information further comprises a unit offset indicator representing position of the media processing unit.

At least one unit offset indicator is generated to correspond to each of the media processing units.

The unit offset indicator represents position of a media processing unit measured from a start position of the MMT asset.

The random access information further comprises a unit size indicator representing size of the media processing unit.

At least one unit size indicator is generated to correspond individually to at least one media processing unit and represents size of the media processing unit.

The random access information further comprises an indicator representing existence of random access information.

In a method for generating an MMT asset for transporting media data in a system meant for transporting coded media data, the present invention provides a computer-readable storage medium storing a program to carrying an method for generating an MMT asset in a computer, the method for generating an MMT asset, comprising receiving media data including a media processing unit (MPU); generating random access information; and generating MMT (MPEG Media Transport) asset by using the media data and the random access information.

The random access information comprises an indicator representing the number of media processing units included in the MMT asset.

The random access information further comprises a unit offset indicator representing position of the media processing unit.

At least one unit offset indicator is generated to correspond to each of the media processing units.

The unit offset indicator represents position of a media processing unit measured from a start position of the MMT asset.

The random access information further comprises a unit size indicator representing size of the media processing unit.

At least one unit size indicator is generated to correspond individually to at least one media processing unit and represents size of the media processing unit.

The random access information further comprises an indicator representing existence of random access information.

In an apparatus for generating an MMT asset for transporting media data in a system meant for transporting coded media data, an apparatus for generating an MMT asset comprises a random access information generating unit generating random access information by receiving media data including a media processing unit; and an MMT asset generating unit generating an MMT asset by using the media data and the random access information.

The random access information comprises an indicator representing the number of media processing units included in the MMT asset.

The random access information further comprises a unit offset indicator representing position of the media processing unit.

The unit offset indicator is generated to correspond to each of the media processing units.

The unit offset indicator stores position of a media processing unit measured from a start position of the MMT asset.

The random access information further comprises a unit size (unit_size) indicator representing size of the media processing unit.

The unit size indicator, corresponding to at least one media processing unit, represents the size of the corresponding media processing unit.

The random access information further comprises an indicator representing existence of random access information.

In a structure of an MMT asset for transporting media data in a system meant for transporting coded media data, the present invention provides an MMT asset structure storing random access information; and media data comprising a media processing unit (MPU).

The MMT asset structure further comprises an indicator representing the number of the media processing units and the MMT asset represents the number of media processing units included in the MMT asset.

The random access information further comprises a unit offset indicator representing position of the media processing unit.

The unit offset indicator in the MMT asset structure corresponds each of the media processing units.

The MMT asset stores the media processing unit sequentially in a memory of the system and the unit offset indicator represents position of a media processing unit measured from a start position of the MMT asset.

The random access information, further comprising a unit size indicator representing the size of the media processing unit, represents the size of the corresponding media processing unit.

The random access information further comprises an indicator representing existence of random access information.

### Advantageous Effects

The structure of an MMT asset and a method and apparatus for generating an MMT asset according to the present invention provides free access to M-units contained in a particular MMT asset by using an indicator representing the positions of M-units and an indicator representing the size of the M-unit.

### DESCRIPTION OF DRAWINGS

The accompany drawings, which are included to provide a further understanding of the present invention and are incorporated into and constitute a part of this specification illustrate embodiments of the present invention and together with the description serve to explain the principles of the present invention.

FIG. 1 is a block diagram illustrating MMT layer structure;

FIG. 2 illustrates a format of unit information (or data or packet format) used for each layer of MMT layer structure;

FIG. 3 is illustrates a concept of MMT package;

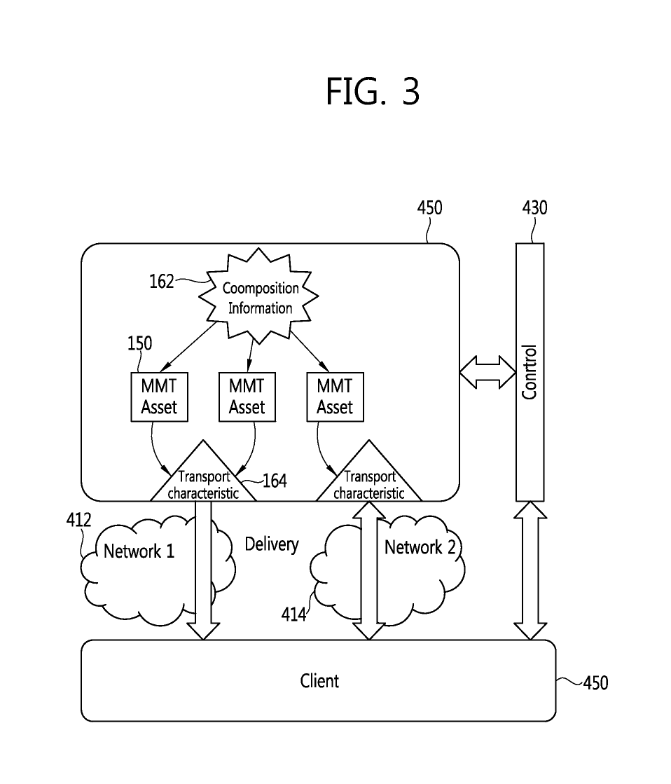

FIG. 4 is a block diagram of an apparatus for generating an MMT asset according to one embodiment of the present invention;

FIG. 5 is a flow diagram of a method for generating an MMT asset according to one embodiment of the present invention; and

FIG. 6 is a structure of an MMT asset according to one embodiment.

### BEST MODE

The present invention can be modified in various ways and various embodiments of the present invention can be realized; thus, this document illustrates particular embodiments in the appended drawings and detailed description of the embodiment will be provided. However, that is not meant for limiting the present invention to the particular embodiments; rather, it should be understood to include every possible modification, equivalent, or substitute of the present invention which belongs to the technical principles and scope of the present invention.

Terms such as first, second, and so on can be used for describing various components but the components should not be limited by the terms. The terms are introduced only for the purpose of distinguishing one component from the others. For example, a first component may be called a second component without departing from the scope of the present invention and vice versa. The term of and/or indicates a combination of a plurality of related items described or any one of a plurality of related items described.

If a component is said to be “linked” or “connected” to a different component, the component may be directly linked or connected to the different component but a third component may exist to connect the two components even though the two components may be connected directly. On the other hand, if a component is said to be “linked directly” or “connected directly” to another component, it should be interpreted that there is no further component between the two components.

Terms used in this document have been introduced only to describe particular embodiment, not intended to limit the scope of the present invention. Singular expression should be interpreted to include plural expressions unless otherwise stated explicitly. Terms such as “include” or “have” are meant to signify existence of embodied characteristics, numbers, steps, behavior, components, modules, and combinations thereof, which should be understood that possibility of existence or addition of one or more characteristics, numbers, steps, behavior, components, modules, and combinations thereof are not precluded beforehand.

Unless otherwise defined, all the terms used in this document, whether they are technical or scientific, possess the same meaning as understood by those skilled in the art to which the present invention belongs. The terms such as those defined in a dictionary for general use should be interpreted to carry the same contextual meaning in the related technology and they should not be interpreted to possess an ideal or excessively formal meaning.

In what follows, with reference to appended drawings, preferred embodiments of the present invention will be described in more detail. For the purpose of overall understanding of the present invention, the same components of the drawings use the same reference symbols and repeated descriptions for the same components will be omitted.

In what follows, definitions of the terms used in this document are introduced.

A system meant for transporting coded media data through a heterogeneous IP network is called an MMT (MPEG Media Transport) system.

A contents component or media component refers to media of a single type or a subset of the media of a single type, where examples include a video track, movie subtitles, or an enhancement layer of video.

Contents are defined as a set of contents components, including a movie, song, and so on.

Presentation is defined as operation carried out by one or more devices for the user to experience one contents component or one service (for example, watching a movie).

A service is defined as one or more contents components transported for presentation or storage.

Service information is defined as meta data describing one service and characteristics and components of the service.

An access unit (AU) is the smallest data entity which can have time information as an attribute.

In the case of coded media data to which time information for decoding and presentation is not assigned, the AU is not defined.

An MMT asset refers to a logical data entity comprising at least one MPU together with the same MMT asset ID or comprising a particular data block together with a format specified by another standard. The MMT asset is the largest data unit to which the same composition information and delivery characteristics are applied.

MMT asset delivery characteristics (MMT-ADC) are descriptions related to a QoS request for delivering an MMT asset. The MMT-ADC helps a particular delivery environment unknown to the outside.

MMT composition information (MMT CI) describes a spatial and temporal relationship between MMT assets.

A media fragment unit (MFU) is a general-purpose container and independent of codecs of any kind, which accepts coded media data that can be consumed independently of a media decoder. In other words, the MFU receives information, which can be used in a transport layer with a size of the information smaller than or equal to that of an access unit

An MMT package is a set of logically structured data, comprising at least one MMT asset, MMT-composition information, MMT-asset delivery characteristics, and descriptive information.

An MMT packet refers to a format of data generated or consumed by MMT protocol.

An MMT payload format is a format indented for an MMT package or payload of an MMT signaling message to be delivered based on the MMT protocol or Internet application layer protocol (for example, RTP).

A media processing unit (MPU) is a general-purpose container independent of codecs of any kind and accepts information related to at least one AU and additional transport and consumption. When it comes to non-timed data, the MPU accepts part of the data which does not belong to the scope of the AU. The MPU is coded media data which is complete on its own and can be processed independently. In this context, processing refers to encapsulation or packetization into the form of MMT package for delivery.

Non-timed data refer to all kinds of data elements consumed without specification of time. A time range specifying data execution or beginning can be assigned to non-timed data.

Timed data refer to data elements related to a particular time for decoding and presentation.

Media data refer to data elements including both the non-timed data and timed data.

A media unit refers to a container including a media fragment unit (MFU) or a media processing unit (MPU).

### MODE FOR INVENTION

In what follows, with reference to appended drawings, preferred embodiments of the present invention will be described in more detail. For the purpose of overall understanding of the present invention, the same components of the drawings use the same reference symbols and repeated descriptions for the same components will be omitted.

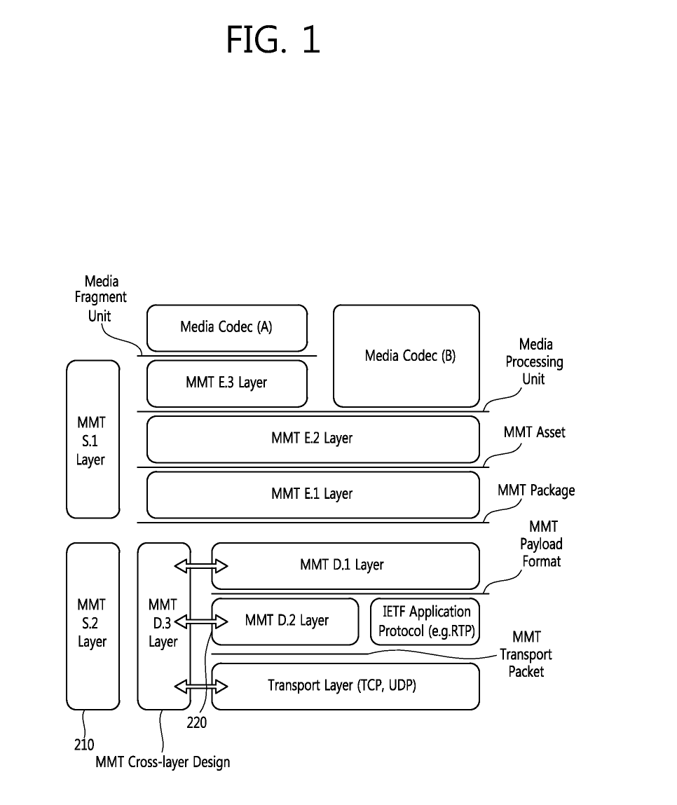

FIG. 1 is a block diagram illustrating MMT layer structure.

With reference to FIG. 1, the MMT layer comprises an encapsulation layer, a delivery layer, and an S layer. The MMT layer operates on top of a transport layer.

The encapsulation layer (E-layer) carries out a function of packetization, fragmentation, synchronization, and multiplexing of transported media.

An encapsulation functional area defines a logical structure of a format for data units to be processed by media contents, MMT package, and an entity compliant with MMT. To provide essential information for adaptive transport, the MMT package specifies components including media contents and their relationship between them. A format for data units is defined for storing or transporting the data units as a payload data compliant with a transport protocol and at the same time, the format is defined for encapsulation of coded media to facilitate conversion between the data units.

As shown in FIG. 1, the encapsulation layer (E-layer) comprises MMT E.1 layer, MMT E.2 layer, and MMT E.3 layer.

The E.3 layer encapsulates a media fragment unit (MFU) provided from a media codec layer A and generates a media processing unit (MPU).

Coded media data from an upper layer is encapsulated into an MFU. The type and value of coded media can be abstracted in such a way that the MFU is used commonly for a particular codec technology. The abstraction helps a lower layer process an MFU without accessing to encapsulated coded media. The lower layer retrieves coded media data from a network or a storage buffer and transports the coded media data to a media decoder. The MFU is equipped with a sufficient number of information media units for carrying out the operation.

The MFU can have a format which is independent of a particular codec and capable of carrying data units consumed independently. The MFU, for example, can be a picture or a slice of video.

An MPU is generated by one MFU or a plurality of MFUs in one group which can be transported and decoded independently. An MPU is also generated by non-timed media which can be transported and executed independently. The MPU specifies the same internal structure as the arrangement and pattern of an MFU which enable fast access to the MFU and partial consumption thereof.

The E.2 layer encapsulates an MPU generated in the E.3 layer and generates an MMT asset.

An MMT asset is a data entity comprising one or more MPUs from a single data source, which is a kind of data unit for which composition information (CI) and transport characteristics (TC) are defined and multiplexed by an MMT payload format and transported according to the MMT protocol. An MMT asset corresponds to a packetized elementary stream (PES), examples of which include video, audio, program information, MPEG-U widget, JPEG image, MPEG-4 file format, M2TS (MPEG transport stream), and so on.

The E.1 layer encapsulates an MMT asset generated in the E.2 layer and generates an MMT package.

The MMT asset is packaged with MMT composition information (MMT-CI) for a further response of the same user experience together with or separately from other functional areas such as transport area and signal area. The MMT package is also packaged together with transport characteristics used for selecting a transport method appropriate for each of MMT assets to satisfy quality of experience of the MMT asset.

The MMT package consists of one or more MMT assets together with additional information such as composition information and transport characteristics (delivery characteristics). Composition information includes information about a relationship between MMT assets and in case the contents comprise a plurality of MMT packages, the composition information further includes information about a relationship between the plurality of MMT packages such as traffic description parameter and QoS descriptor. The MMT package corresponds to a program of the MPEG-2 TS.

The delivery layer carries out network flow multiplexing of media transported through a network, network packetization, QoS control, and so on.

A delivery functional area defines a payload format and application layer protocol. The application layer protocol according to the present invention features characteristics enhanced for delivery of MMT packages compared with the conventional application layer protocol meant for delivery of multimedia including multiplexing. A payload format is defined to deliver coded media data irrespective of media type or encoding method used.

As shown in FIG. 1, the delivery layer (D-layer) comprises MMT D.1 layer, MMT D.2 layer, and MMT D.3 layer.

The D.1 layer receives an MMT package generated in the E.1 layer and generates an MMT payload format. The MMT payload format transports an MMT asset, which is a payload format for transporting information used for consumption based on the MMT application protocol or other existing application transport protocol such as RTP. The MMT payload includes fragments of the MFU together with information such as AL-FEC.

The D.2 layer receives the MMT payload format generated in the D.1 layer and generates an MMT transport packet or MMT packet. The MMT transport packet or MMT packet is a data format used for an application transport protocol for MMT.

The D.3 layer, employing a cross layer design, supports QoS by providing a function of exchanging information between layers. For example, the D.3 layer carries out QoS control by using the QoS parameters of the MAC/PHY layer.

The S layer carries out a signaling function. For example, the S layer carries out a signaling function meant for initialization, control, and management of a session of transported media; a server-based and/or client based trick mode; service discovery, synchronization, and so on.

A signaling functional area defines a format of a message used for managing transport and consumption of an MMT package. The message for consumption management is used for transporting a structure of the MMT package while a message for delivery management is used for transporting a structure of a payload format and composition of a protocol involved.

As shown in FIG. 1, the S layer comprises MMT S.1 layer and MMT S.2 layer.

The S.1 layer carries out a function of media session initialization/termination, media session presentation/control, interfacing with the delivery layer D and encapsulation layer E, and so on. The S.1 layer can define a format for control messages communicated between applications for media presentation session management.

The S.2 layer defines a format of a control message exchanged between delivery end-points of the delivery layer D, the control message being intended for flow control, delivery session management, delivery session monitoring, error control, and hybrid network synchronization control.

To support operation of the delivery layer, the S.2 layer includes delivery session establishment and release, delivery session monitoring, flow control, error control, resource reservation for an established delivery session, signaling for synchronization in a hybrid delivery environment, and signaling for adaptive delivery. The S.2 layer provides signaling required between a sender and a receiver. In other words, as described above, the S.2 layer provides signaling required between the sender and the receiver to support the operation of the delivery layer. Also, the S.2 layer carries out a function of interfacing with the delivery layer and the encapsulation layer.

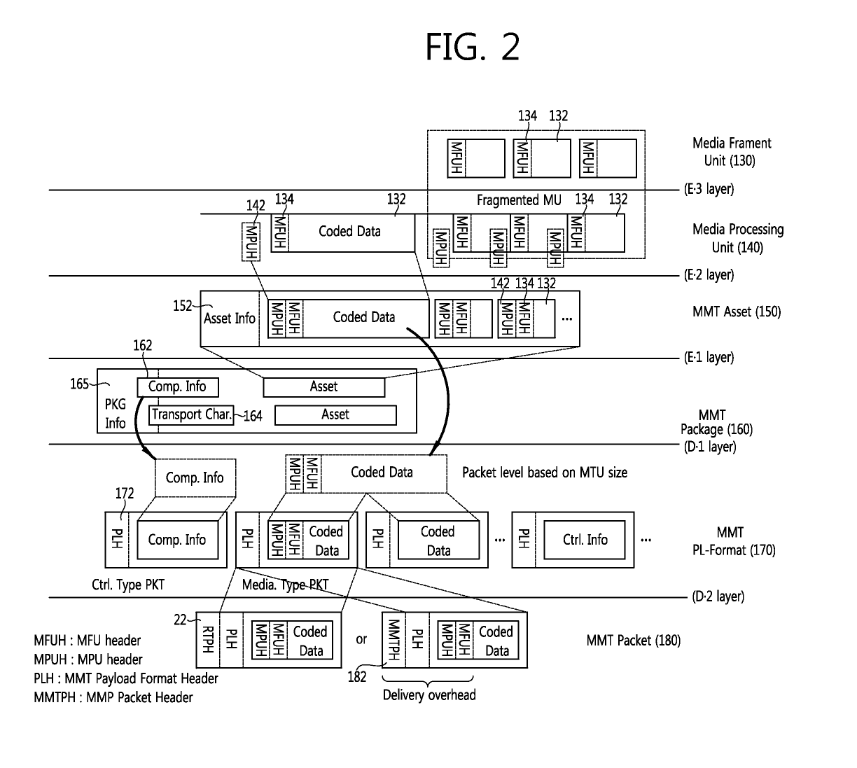

FIG. 2 illustrates a format of unit information (or data or packet format) used for each layer of MMT layer structure of FIG. 1.

A media fragment unit (MFU) 130 comprises a coded media fragment data 132 and a media fragment unit header (MFUH) 134. The media fragment unit 130 employs a general container format independently of a particular codec and carries the smallest data unit which can be consumed independently in a media decoder. The MFUH 134 includes additional information such as media characteristics—for example, loss-tolerance. The MFU 130 may correspond to a picture or slice of a video, for example.

The media fragment unit (MFU) defines a format by which part of AU is encapsulated in a transport layer for carrying out adaptive transport in the range of MFU. The MFU is used for transporting a particular format of coded media so that part of AU is decoded independently or discarded.

An identifier is assigned to each MFU for distinguishing one MFU from the others and an MFU can have information about a general relationship among MFUs within the same AU. Dependencies among MFUs in the same AU are explained and an MFU-related priority order is explained through the information above. The information may be used for dealing with transport in a lower transport layer. For example, to support QoS transport under insufficient bandwidth, the transport layer omits transport of MFUs which may be discarded safely. Detailed descriptions of the structure of the MFU will be provided below.

An MPU comprises a plurality of media fragment units 130. An MPU employs a general container format independently of a particular codec and comprises an access unit and equivalent media data. An MPU can have a timed data unit or a non-timed data unit.

An MPU is a data block processed independently and completely by an entity compliant with the MMT specifications. The MPU may comprise at least one MFU or part of data compliant with a format defined by a different standard.

A single MPU accepts an integral number of at least one AU or non-timed data. An AU can be delivered from at least one MFU in the case of timed data but one AU cannot be divided into a plurality of MPUs. In the case of non-timed data, one MPU accepts part of non-timed data processed independently and completely by an entity compliant with the MMT specifications.

An MPU can be identified uniquely within an MMT package by a sequence number and an associated asset ID distinguishing the current MPU from the others.

An MPU can have at least one arbitrary access point. The first byte of the MPU payload can be made to always begin with an arbitrary access point. In the case of timed data, the above fact indicates that the decoding order of a first MFU in the MPU payload is always 0. For timed data, a presentation period and decoding order of each AU can be transported to inform a presentation time. Not having an initial presentation time of its own, the presentation time of a first AU of one MPU can be specified in the composition information. The composition information can specify a first presentation time of an MPU. Detailed descriptions thereof will be provided later.

An MMT asset comprises a plurality of MPUs. The MMT asset 150 is a data entity comprising a plurality of MPUs (timed or non-timed data) generated from a single data source, where MMT asset information 152 includes additional information such as asset packaging metadata and data type. The MMT asset 150, for example, includes video, audio, program information, MPEG-U widget, JPEG image, MPEG-4 file format, PES (Packetized Elementary Stream), M2TS (MPEG transport stream), and so on.

The MMT asset is a logical data entity accommodating coded media data. The MMT asset comprises an MMT asset header and coded media data. The coded media data can be treated as a collective reference group referenced by the same MMT asset ID. A kind of data which can be consumed individually by an entity connected directly to an MMT client can be considered as an individual MMT asset. Examples of data types that can be considered as an individual MMT asset include MPEG-2 TS, PES, MP4 file, MPEG-U widget package, JPEG file, and so on.

Coded media of the MMT asset may correspond to timed or non-timed data. Timed data refers to audiovisual media data which requires synchronized decoding and presentation of particular data at a specified time. Non-timed data is a kind of data that can be decoded and provided at an arbitrary time depending on service provision or user interaction.

A service provider can generate a multimedia service by integrating MMT assets and disposing the MMT assets along spatio-temporal axes.

An MMT package 160 comprises one or more MMT assets 150. The MMT assets are multiplexed or concatenated within the MMT package.

The MMT package refers to a container format meant for an MMT asset and configuration information. The MMT package provides a reservoir of MMT assets and configuration information for an MMT program.

An MMT program provider encapsulates coded data into MMT assets and generates configuration information specifying the MMT assets and the temporal and spatial layout of their delivery characteristics. The MU and MMT asset can be transported directly by employing the D.1 payload format. The configuration information is transported through a C.1 presentation session management message. However, an MMT program provider and a client allowing a relay of MMT programs or further re-use of the MMT programs stores configuration information by using MMT package format.

In parsing an MMT package, the MMT program provider determines in which transport path (for example, broadcast or broadband) the MMT asset is provided to the client. The configuration information of the MMT package is transported through the C.1 presentation session management message together with transport-related information.

The client receives the C.1 presentation session management message and figures out which MMT program is possible and how an MMT asset for the corresponding MMT program is received.

The MMT package is also transported by using the D.1 payload format. The MMT package is packetized according to the D.1 payload format and thus transported. The client receives packetized MMT packages and constructs the whole or part of the packages and consumes the MMT program.

The package information 165 of the MMT package 160 comprises configuration information. The configuration information comprises additional information such as a list of MMT assets, package identification information, composition information 162, and transport characteristics 164. The composition information 162 includes information about a relationship between MMT assets 150.

The composition information 162 can further comprise information representing a relationship between MMT packages in case the contents comprise a plurality of MMT packages. The composition information 162 may comprise information about a temporal, spatial, and adaptive relationship within the MMT package.

Similarly to the information supporting transport and presentation of the MMT package, the composition information in the MMT provides information about a spatial and temporal relationship between MMT assets within the MMT package.

MMT-CI is a descriptive language providing such information based on extension of HTML5. While the HTML5 has been designed to describe page-based presentation of text-oriented contents, MMT-CI mainly expresses a spatial relationship between sources. To support representing a temporal relationship between MMT assets, the MMT-CI can be extended to include MMT asset-related information in the MMT package; time information meant for determining transport of MMT assets and their consumption order; and additional attributes of HTML5 for media components consuming various MMT assets. Detailed descriptions thereof will be provided later.

Transport characteristics information 164 comprises information about transport characteristics, providing information required for determining delivery conditions of individual MMT assets (or MMT packets). Transport characteristics information comprises a traffic description parameter and QoS descriptor.

The traffic description parameter comprises bitrate and priority information about a media fragment unit (MFU) 130 or MPU. The bitrate information includes, for example, information about whether an MMT asset employs a variable bitrate (VBR) or constant bitrate (CBR), a bitrate guaranteed for a media fragment unit (MFU) (or MPU), and a maximum bitrate for the media fragment unit (MFU) (or MPU). The traffic description parameter can be used for a server and a client lying on a transport path and other constituting elements, which, for example, includes information about a maximum size of a media fragment unit (MFU) (or MPU) within the MMT asset. The traffic description parameter can be updated periodically or non-periodically.

The QoS descriptor includes information for controlling QoS, including delay information and loss information, for example. The loss information includes a loss indicator indicating whether or not delivery loss is allowed for an MMT asset. For example, if the loss indicator is ‘1’, it indicates a ‘lossless’ case whereas in the case of ‘0’, it indicates a ‘lossy’ case. The delay information includes a delay indicator used for determining sensitivity of a transport delay of an MMT asset. The delay indicator indicates whether the type of an MMT asset corresponds to conversation, interactive, real time, or non-real time.

Contents can be comprised of one MMT package or a plurality of MMT packages.

In case a plurality of MMT packages comprise the contents, composition information or configuration information describing a temporal, spatial, and adaptive relationship among the plurality of MMT packages exists inside of one MMT package among the MMT packages or outside the MMT packages.

For example, in the case of hybrid delivery, part of content components is transported through a broadcast network while the remaining part of the content components is transported through a broadband network. For example, in the case of a plurality of AV streams comprising a multi-view service, one stream may be transported through a broadcast network whereas the other streams are transported through a broadband network; each of AV streams is multiplexed and provided to a client terminal and stored therein. Similarly, in another operating scenario, application software such as a widget may be transported through the broadband network whereas AV streams (AV programs) are transported through the existing broadcast network.

In the case of the multi-view service scenario and/or widget scenario introduced above, the whole of AV streams can be integrated into a single MMT package. In this case, one of the AV streams is stored only in one client terminal; storage contents become part of the MMT package; the client terminal has to record composition information or configuration information once again; and the contents recorded again becomes a new MMT package independent of a server.

In the case of the multi-view service scenario and/or widget scenario introduced above, each AV stream can be a single MMT package. In this case, a plurality of MMT packages comprise the contents; composition information or configuration information, which is recorded in units of MMT package in the storage and represents a relationship between MMT packages, is required.

Composition information or configuration information included in one MMT package can be used for referring to an MMT asset in another MMT package and can be used for representing an entity outside of the MMT package referring to the MMT package in an out-band situation.

Meanwhile, to inform the client terminal of a list of MMT assets 160 provided by a service provider and a path available for delivering the MMT package 160, the MMT package 160 is interpreted into service discovery information through a control layer C and an information table for service discovery is incorporated into an MMT control message.

The server, having divided multimedia contents into a predetermined number of segments, assigns URL information to each of the segments and stores the URL information for each segment into a media information file and transports the media information file to a client.

The media information file is called in various ways according to a standardization body which develops a HTTP streaming standard, including ‘media presentation description (MPD)’ and ‘manifest file’. In what follows, the media information file is referred to as a media presentation description (MPD).

From now on, a cross layer interface is described.

A cross layer interface (CLI) is intended for exchanging QoS-related information between lower layers including the application layer and MAC/PHY layer and is a single entity which provides a QoS supporting means. While a lower layer provides upper-bound QoS information such as a network channel status, the application layer provides information related to media characteristics as lower-bound QoS information.

The cross layer interface provides an integrated interface among various network layers including the application layer, the IEEE802.11 WiFi, the IEEE802.16 WiMAX, 3G, 4G LTE, and so on. Common network parameters of popular network standards are extracted as NAM parameters for static and dynamic QoS control of a real-time media application going through various types of networks. The NAM parameters can include a BER value, which is bit error rate. BER can be measured in the PHY or MAC layer. Also, the NAM parameters provide identification of a lower network, available bit rate, buffer status, peak bit rate, service unit size, and service data unit loss rate.

Two different methods can be used for providing NAM. A first method is to provide an absolute value while a second method is to provide a relative value. The second method can be used for updating the NAM while it stays connected.

The application layer provides lower-bound QoS information related to media characteristics of the lower layer. Two types of lower-bound information are available such as MMT asset level information and packet level information. The MMT asset information is used for exchanging capacity in the lower layer and/or resource (re)allocation. The packet level lower-bound information is recorded in a relevant field of each packet in the lower layer for identifying a QoS level supported.

The lower layer provides upper-bound QoS information for the application layer. The lower layer provides time varying information related to the network status, which enables fast and more precise QoS control in the application layer. The upper-bound information is represented in the form of abstraction to support a heterogeneous network environment. These parameters are measured in the lower layer and are read in the application layer periodically or according to a request of the MMT application.

The MMT asset according to one embodiment of the present invention provides an index for the media processing unit (MPU) or media unit (M-unit) to support random access to the MPU or M-unit belonging to the MMT asset. The corresponding index, being disposed in the header of the MMT asset, enables a device making use of media data to access any M-unit within the MMT asset at one transaction through the index. In the following, descriptions of the M-unit apply equally to the media processing unit; therefore, any MPU within the MMT asset can be accessed through one transaction. Particular descriptions of the MPU can also be applied to the M-unit.

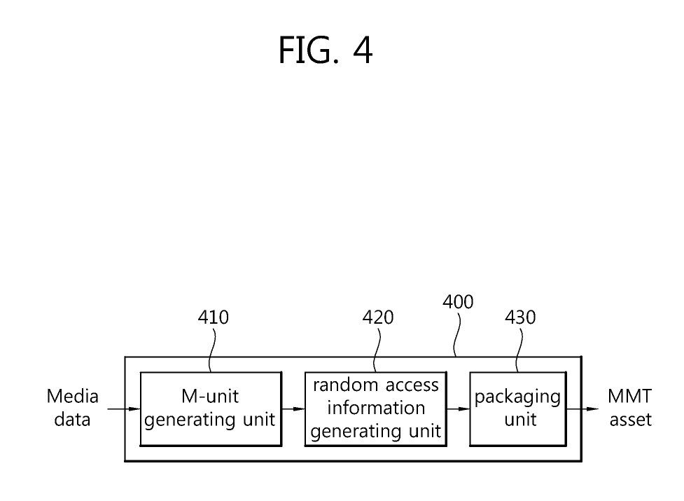

FIG. 4 is a block diagram of an apparatus for generating an MMT asset according to one embodiment of the present invention.

The apparatus for generating an MMT asset 400 receives media data and generates an MMT asset. The apparatus for generating an MMT asset 400 comprises an M-unit generating unit 410, a random access information generating unit 420, and a packaging unit 430. The M-unit generating unit 410 receives media data and divides the media data into M-units of a particular size. The size of an M-unit can differ from that of the other M-units. The M-unit generating unit 410 calculates the size of a generated M-unit and the number of M-units generated. The M-unit generating unit 410 is an optional implementation operation of which can be skipped if the apparatus for generating an MMT asset 400 receives pre-divided M-units.

The random access information generating unit 420 receives data from the M-unit generating unit 410 and generates random access information. The random access information generating unit 420 receives from the M-unit generating unit 410 any one of M-unit, size of generated M-unit, and the number of generated M-units. If the random access information generating unit 420 receives an M-unit directly since no M-unit generating unit 410 is employed or none of the information above is available, the random access information generating unit 420 can generate at least either of the size of M-unit and the number of M-units directly. The random access information includes an indicator indicating whether part of an MMT asset is randomly accessible or a random access point indicator indicating whether an M-unit is randomly accessible.

The packaging unit 430 receives random access information and M-unit from the random access information generating unit 420 and an MMT asset is packaged by the packaging unit 430. The packaging unit 430 receives from the random access information generating unit at least one of a data unit, size of generated M-unit, the number of generated M-units, and random access information; and then an MMT asset is packaged by the packaging unit 430. The packaging unit 430 may receive an M-unit directly for its operation. The packaging unit 430 may receive directly from the M-unit generating unit 410 any one of an M-unit, size of the generated M-unit, and the number of generated M-units.

At least two of the M-unit generating unit 410, random access information generating unit 420, and packaging unit can be merged into a single module.

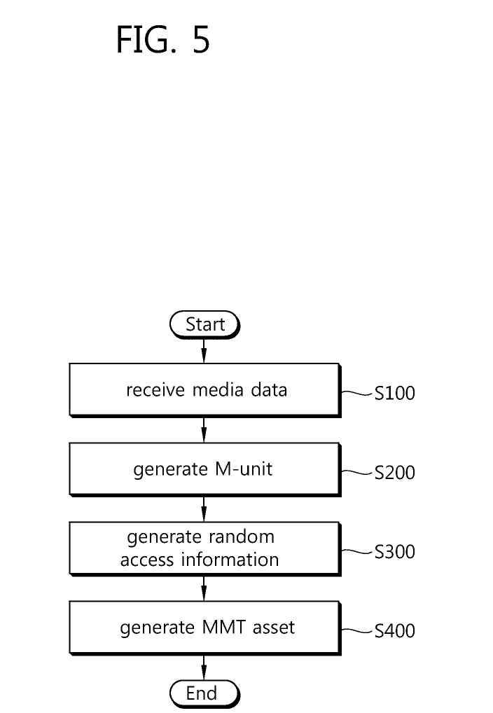

FIG. 5 is a flow diagram of a method for generating an MMT asset according to one embodiment of the present invention.

First, an apparatus for generating an MMT asset 400 receives media data S100. Next, the apparatus for generating an MMT asset 400 generates an M-unit S200.

The M-unit generating unit 410 receives media data and divides the media data into predetermined units to generate an MMT asset. The media data is encapsulated into M-units and packaged into an MMT asset. The M-unit generating unit 410, while encapsulating the media data into M-units, labels the encapsulated M-units for identification and calculates the number of M-units and size of each M-unit. The M-unit generating unit 410 delivers at least one of the generated M-unit, labeling information of the M-unit, and the calculated number and sizes of M-units to the random access information generating unit 420. If the M-unit generating unit 410 receives an M-unit directly, the M-unit generating step can be skipped.

Next, random access information is generated S300. The random access information generating unit 420 generates random access information by referring to media data or by using the information of an M-unit received from the M-unit generating unit 410. The random access information is required for random access. The random access information can include a random access flag which indicates whether an M-unit has a random access point. The random access information can be delivered to the packaging unit in accordance with the label of the M-unit. The random access information generating unit 420 can deliver received information and random access information to the packaging unit.

Next, an MMT asset is generated S400. Media data or at least one of M-unit, labeling information of the M-unit, the number of M-units, size of the M-unit, and random access information is packaged to generate an MMT asset by the packaging unit 430.

In what follows, described will be the structure of an MMT asset generated by a method for generating an MMT asset according to one embodiment of the present invention. An MMT asset according to one embodiment of the present invention can store at least two of the label of an M-unit, the M-unit, position information of the M-unit, and random access information of the M-unit by associating the two with each other. Each of the information can be stored being associated with a label of the M-unit. On the other hand, by storing the M-unit and the position information of the M-unit and utilizing the random access information of the M-unit sequentially, the M-unit and random access information can be stored being associated with each other without explicitly using the label of the M-unit.

Also, according to one embodiment of the present invention, position information and random access information of all M-units are not necessarily packaged into an MMT asset; by making use of a set of at least one M-unit with a random access point, position information and random access information of M-units not equipped with a random access point can be omitted.

Similarly, a structure of an MMT asset which includes only those M-units with a random access point can be generated. The above structure can be used for the case where random access information is generated before media data is encapsulated and by applying the random access information to the step of encapsulating the media data, M-units without a random access point are merged into the M-units having a random access point, thus generating only those M-units providing a random access point. Also, an indicator indicating the number of M-units and sizes thereof can be employed separately.

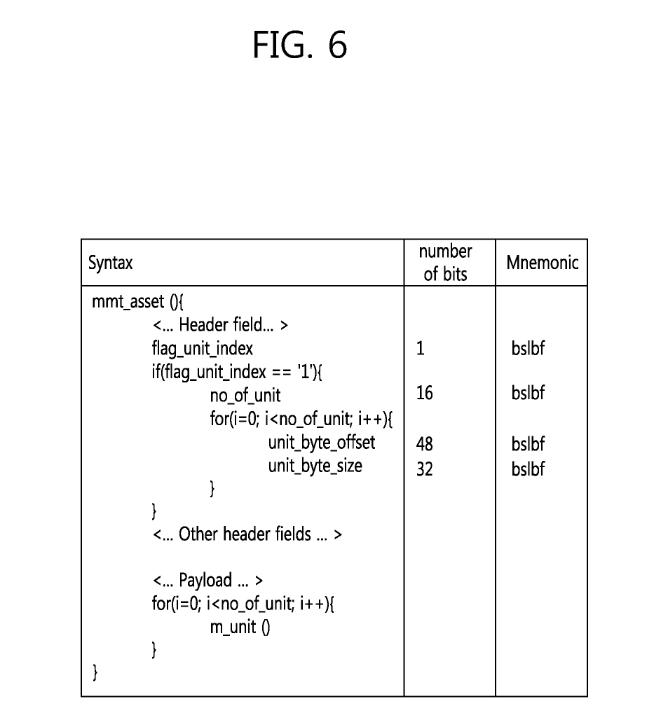

FIG. 6 is a structure of an MMT asset according to one embodiment. FIG. 6 illustrates syntax of random access information included in an MMT asset according to one embodiment of the present invention.

An MMT asset can be divided into a header field and a payload. The header field comprises random access information and data required for using the MMT asset. The embodiment of FIG. 6 shows the structure of an MMT asset in case M-units all have a random access point. The header field of the MMT asset comprises flag_unit_index, no_of_unit, unit_byte_offset and unit_byte_size.

flag_unit_index indicates whether the MMT asset has random access information about the M-unit. As shown in the embodiment of FIG. 6, if flag_unit_index has a value of 1, it indicates that the header of mmt_asset is equipped with the information related to a random access index about the M-unit. The information related to a random access index comprises no_of_unit, unit_byte_offset and unit_byte_size. no_of_unit is meant for representing the number of all M-units included in the MMT asset. unit_byte_offset represents a byte offset at which the corresponding M-unit is located. unit_byte_offset may correspond to a byte offset at which the corresponding M-unit is positioned from a start byte position of the M-unit. unit_byte_size indicates the byte size of the corresponding M-unit.

The header field of the MMT asset according to the syntax of FIG. 6 is so arranged that if the flag_unit_index indicator is 1, the no_of_unit indicator is disposed subsequent to the flag_unit_index indicator and as many unit_byte_offset indicators and unit_byte_size indicators as the value indicated by the no_of_unit indicator are arranged subsequent to the no_of_unit indicator. After as many arrays of unit_byte_offset and unit_byte_size indicators as the value indicated by the no_of_unit indicator are disposed repeatedly, an indicator representing different information can be disposed in the header field.

In case the flag_unit_index indicator is 0, no_of_unit, unit_byte_offset, and unit_byte_size may not be disposed but another indicator may be arranged in the header field.

After description of the header field of the MMT asset is completed, the MMT asset is allowed to have a payload. The payload can be disposed in such a way that the M-unit is arranged repeatedly as many times as the value of the no_of_unit indicator.

1. In a method for generating an MMT asset for transporting media data in a system meant for transporting coded media data, a method for generating an MMT asset, comprising:
receiving media data including a media processing unit (MPU);
generating random access information; and
generating MMT (MPEG Media Transport) asset by using the media data and the random access information.

2. The method of claim 1, wherein the random access information comprises an indicator representing the number of media processing units included in the MMT asset.

3. The method of claim 2, wherein the random access information further comprises a unit offset indicator representing position of the media processing unit.

4. The method of claim 3, wherein at least one unit offset indicator is generated to correspond to each of the media processing units.

5. The method of claim 3, wherein the unit offset indicator represents position of a media processing unit measured from a start position of the MMT asset.

6. The method of claim 3, wherein the random access information further comprises a unit size indicator representing size of the media processing unit.

7. The method of claim 6, wherein at least one unit size indicator is generated to correspond individually to at least one media processing unit and represents size of the media processing unit.

8. The method of claim 1, wherein the random access information further comprises an indicator representing existence of random access information.

9. A computer-readable storage medium storing a program to carry out the method according to claim 1 in a computer.

10. In an apparatus for generating an MMT asset for transporting media data in a system meant for transporting coded media data, an apparatus for generating an MMT asset, comprising:
a random access information generating unit generating random access information by receiving media data including a media processing unit; and
an MMT asset generating unit generating an MMT asset by using the media data and the random access information.

11. The apparatus of claim 10, wherein the random access information comprises an indicator representing the number of media processing units included in the MMT asset.

12. The apparatus of claim 10, wherein the random access information further comprises a unit offset indicator representing position of the media processing unit.

13. The apparatus of claim 12, wherein the unit offset indicator is generated to correspond to each of the media processing units.

14. The apparatus of claim 12, wherein the unit offset indicator represents position of a media processing unit measured from a start position of the MMT asset.

15. The apparatus of claim 10, wherein the random access information further comprises a unit size indicator representing size of the media processing unit.

16. The apparatus of claim 15, wherein at least one unit size indicator is generated to correspond individually to at least one media processing unit and represents size of the media processing unit.

17. The apparatus of claim 10, wherein the random access information further comprises an indicator representing existence of random access information.

18. In a structure of an MMT asset for transporting media data in a system meant for transporting coded media data, an MMT asset structure
storing random access information; and
media data comprising a media processing unit (MPU).

19. The MMT structure of claim 18, wherein the MMT asset structure further comprises an indicator representing the number of the media processing units and the MMT asset represents the number of media processing units included in the MMT asset.

20. The MMT structure of claim 19, wherein the random access information further comprises a unit offset indicator representing position of the media processing unit.

21. The MMT structure of claim 20, wherein the unit offset indicator in the MMT asset structure corresponds each of the media processing units.

22. The MMT structure of claim 20, wherein the MMT asset stores the media processing unit sequentially in a memory of the system and the unit offset indicator represents position of a media processing unit measured from a start position of the MMT asset.

23. The MMT structure of claim 20, wherein the random access information, further comprising a unit size indicator representing the size of the media processing unit, represents the size of the corresponding media processing unit.

24. The MMT structure of claim 18, wherein the random access information further comprises an indicator representing existence of random access information.
